(19) United States
(12) Patent Application Publication
(10) Pub. No.: US 2026/0289100 A1
(43) Pub. Date: Sep. 24, 2026

(54) SYSTEM AND METHOD FOR MANAGEMENT OF STRUCTURED CONTENT

(71) Applicant: Esko Software BV, Gent (BE)

(72) Inventor: Karsten DAEMEN, Gent (BE)

(73) Assignee: Esko Software BV, Gent (BE)

(21) Appl. No.: 18/881,091

(22) PCT Filed: Jul. 5, 2023
(86) PCT No.: PCT/IB2023/056974

§ 371 Date: Jan. 3, 2025

Related U.S. Application Data
(60) Provisional application No. 63/358,402, filed on Jul. 5, 2022.

(51) Int. Cl. G06F 40/186

(52) U.S. Cl. CPC G06F 40/186

(57) ABSTRACT

A computer-implemented process for creating artwork associated with a selected product. The process includes receiving and storing in a computer memory media, an updatable database embodying machine-readable instructions corresponding to one or more instances of textual content information relating to the selected product, and generating, using the computer processor, a first artwork template file for a first structured document (e.g. embodying packaging or label artwork) and a second artwork template file for a second structured document different from the first structured document (e.g. embodying non-packaging, non-labelling-related document). Each instance has a unique identifier but is devoid of any stylistic or positional information. The first and second artwork templates include all stylistic and positional information associated with presentation of the instance in the respective first and second structured documents.

### BACKGROUND OF THE INVENTION

Manufacturers of certain products, in particular products in highly regulated fields such as pharmaceuticals, typically are mandated to provide specific content (i.e. warnings, caveats, ingredients, etc.) on or in product packaging, advertising, instructions for use (IFUs) and other product inserts, and regulatory filings. This informational content may need to be modified for different jurisdictions to reflect different requirements and to provide the information in any and all languages relevant to the jurisdiction. This content may also need updating from time to time, due to changes in regulations, new information, and changes in product or packaging configuration. Manufacturers in the pharmaceutical field customers are anecdotally reporting an experienced increase in product related updates (~40%) triggered by product launches, health authority requirements, new indications, quality updates, and the like. Pharma/life science companies are challenged not only to provide this information on packaging, but also in IFUs and submission documents to various regulatory agencies to meet SPL, QRD, or other standards. As is understood by those in the field, Structured Product Labeling (SPL) is a document markup standard approved by Health Level Seven (HL7) and adopted by the United States (US) Food and Drug Administration (FDA) as a mechanism for exchanging product and facility information. Likewise, the European Medicines Agency's (EMA) Working Group on Quality Review of Documents (QRD) develops, reviews and updates templates for product information for use by applicants and marketing authorization holders for human medicines. The many touch points and systems make it complex and time consuming for manufacturers to remain in compliance.

Manufacturers typically create unstructured documents replicated across multiple systems that extends development time, adds to the costs to bring a drug to market, creates excessive cost in rework, and leaves manufacturers open to errors and omissions.

### SUMMARY OF THE INVENTION

One aspect of the invention relates to a computer-implemented process for creating artwork associated with a selected product. The process includes receiving and storing in a computer memory media, an updatable database embodying machine-readable instructions corresponding to one or more instances of textual content information relating to the selected product, and generating, using the computer processor, a first artwork template file for a first structured document and a second artwork template file for a second structured document. Each instance has a unique identifier but is devoid of any stylistic or positional information. The first artwork template file and the second artwork template file each include at least one first placeholder embodying the unique identifier corresponding to at least one of the one or more instances of content information accessed from the database. The first artwork template file and second artwork template file each comprise all stylistic and positional information associated with presentation of the at least one instance in the respective first and second structured documents. The second structured document is different from the first structured document. The first structured document may embody packaging or label artwork and second structured document may embody a non-packaging, non-labelling-related document, such as a regulatory submission, an e-published document, or a printed physical document, such as instructions for use and/or a product insert.

Another aspect of the invention relates to a computer-implemented management system for creating structured documents associated with a selected product. The system includes a computer processor; a user interface connected to the computer processor; non-transitory computer memory media accessible by the computer processor and having a first portion programmed with machine-readable instructions for causing the computer processor to execute the steps as described above.

Yet another aspect of the invention relates to non-transitory computer memory media programmed with machine-readable instructions for causing a computer processor to execute the steps as described above,

The selected product associated with any of the processes, systems, and computer memory media as described herein may be a healthcare-related product, such as a pharmaceutical, nutraceutical, cosmeceutical, medical or biomedical device, or a food-related product.

The one or more instances of user-inputted information associated with any of the processes, systems, and computer memory media as described herein may be include, for example, information relating to dosage or administration of the selected product, form or strength of the selected product, indications or usage for the selected product, warnings or precautions relating to the selected product, adverse reactions associated with the selected product, data regarding use in specific populations of the selected product, material changes in the selected product over a predefined amount of time, qualitative and quantitative information about the selected product, and compositional structure of the selected product.

### BRIEF DESCRIPTION OF THE DRAWINGS

FIG. 1 is a schematic illustration of attributes of an exemplary system and method of an embodiment of the invention.

FIG. 2 is a schematic illustration of an exemplary prior art information flow associated with creating a structured document.

FIG. 3 is a schematic illustration of an exemplary information flow associated with creating a structured document in accordance with an embodiment of the invention.

FIG. 4 is a more detailed schematic illustration of the exemplary information flow associated with creating a structured document in accordance with an embodiment of the invention.

FIG. 5 is a schematic illustration of aspects of an exemplary system and method of an embodiment of the invention.

FIG. 6 is a schematic illustration of aspects of supporting hardware associated with exemplary embodiments of the invention.

### DETAILED DESCRIPTION OF THE INVENTION

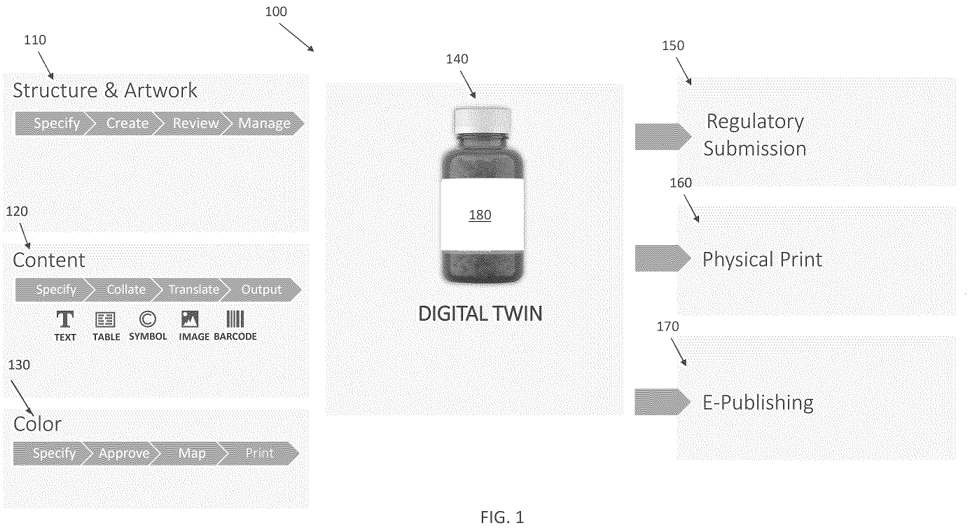

Embodiments of the invention provide a system 100 such as that illustrated in FIG. 1, that permits users to specify, create, review, and manage structure and artwork 110 (e.g. aesthetic features such as but not limited to style, font, and template layout) separate and apart from the specification of content 120 or color, 130, so that a singular repository for content can be used in multiple endpoint structures for that content. By creating a “digital twin” 140 for each unit of structured content, the same content and color themes can be used for regulatory submissions 150, physical printed documents (e.g. IFUs) 160, e-publishing 170, as well as product packaging (not shown). Although depicted with structure, content, and color as separate categories, it should be understood that fewer or more categories may be provided, with content separate from non-content categories. As depicted, digital twin includes label 180 that is devoid of content (in view of size limitations for patent drawings), but it should be understood that label 180 typically includes both textual and graphical information, including branding, artwork, logos, bar codes, use and ingredient information, and the like.

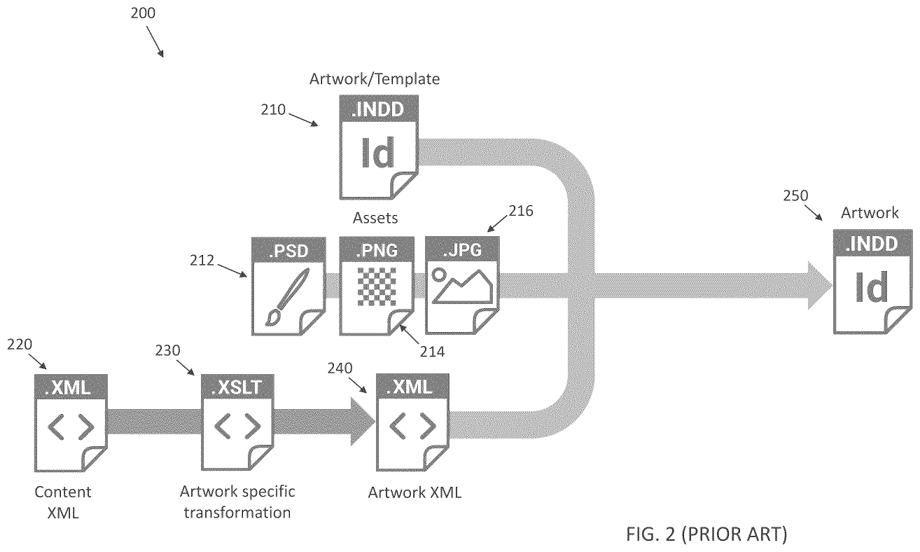

As depicted in FIG. 2, prior art systems 200 for merging an artwork/template 210 for a document, artwork assets in the form of .PSD, .PNG, and .JPG files (212, 214, 216, respectively), and content, typically involve transforming the basic content (e.g. provided the form of an Extensible Markup Language (.XML) file) 220 first to an Artwork-specific transformation file (e.g. an .XSLT file) 230 and then to an Artwork XML file 240, before merging the content, assets, and artwork/template together into the artwork product (e.g. an .INDD file for use with InDesign software) 250. The Artwork-specific transformation file contains the various style, font, and layout information required to map the content onto the template.

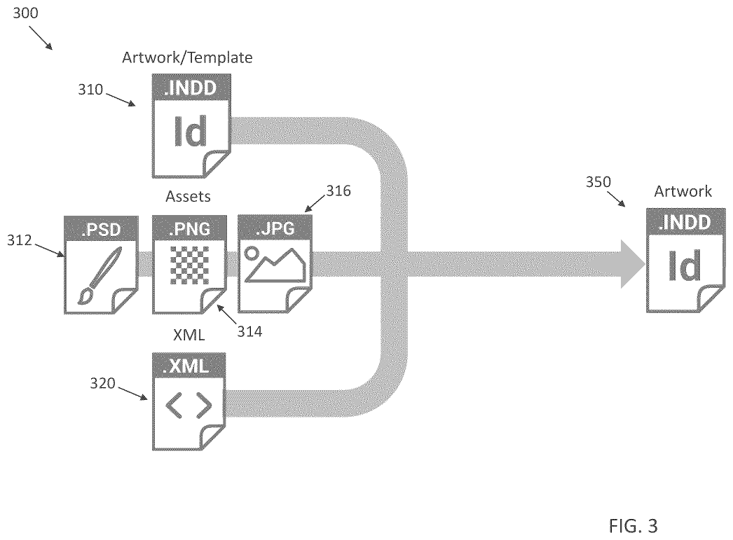

By contrast, as depicted in FIG. 3, embodiments of the present invention permit an artwork/template 310 file with features as further described below, artwork assets 312, 314, 316, and content .XML file 320 to be merged to form the artwork file 350 without creating an Artwork-specific transformation file.

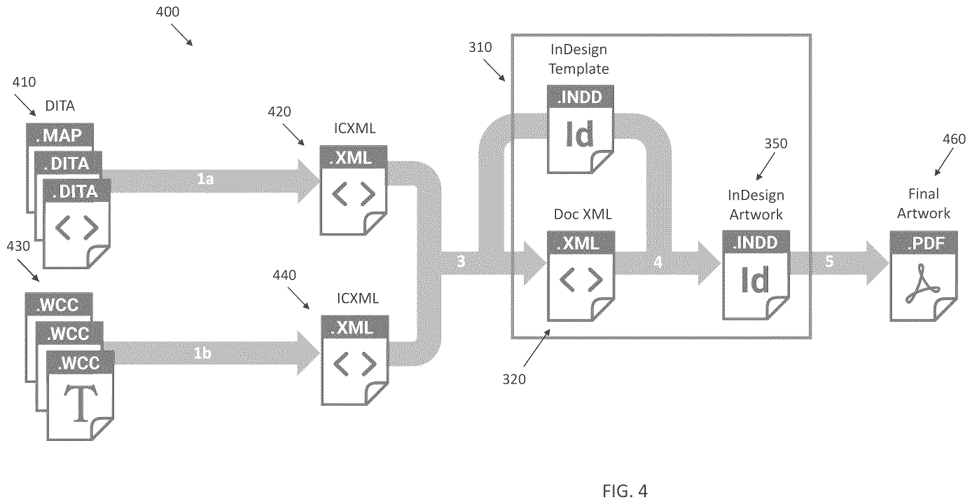

As shown in more detail in FIG. 4, in one embodiment, the process may include providing content in the form of Darwin Information Typing Architecture (.DITA) formatted files and .MAP files 410 that are used for creating a first .XML file 420 in step 1a, and one or more WebCenter Content (WCC) files 430 that are used for creating a second .XML file 440 in step 1b. Those respective .XML files can be merged in step 3 into the singular .XML file 320 as shown in FIG. 3, which file is merged with InDesign template file .INDD 310 in step 4 to create the InDesign Artwork file .INDD 350, which file can then be used in step 5 for creating a consolidated (e.g. PDF) file 460 suitable for further processing, including printing. Step 4 includes opening the InDesign template/artwork 310 and applying the content by importing the XML 320, which pulls in other assets (e.g. 312, 314, 316) that are referenced from the XML.

In contrast to the prior art, the .INDD template file 310 includes all locations and style specifications to be applied to each unit of content supplied by the content .XML file 320. Each unit of content provided in the .XML file 320 includes a unique identifier (e.g. Header 1) that maps to the same unique identifier in the .INDD template file 310. Thus, the content (without stylistic and positional information) can be merged with the template, wherein the template contains all of the positional and stylistic information. The .INDD template file 310 can be created by a relatively less trained individual than is required to create the prior art .XSLT file 230. The separation of template creation step and the content creation step allows a singular content database to be used with a plurality of templates, and changes in content to be readily leveraged across multiple documents.

In contrast to prior art methods, .XML file 320 is generic and can be used for different artworks. It does not depend an artwork specific transformation. All styling configuration is contained within the artwork template 310. Specific naming rules are used to determine what style should be used for the content inside a tagged artwork element. While this approach may not be as flexible as the prior art method depicted in FIG. 2, the artwork template creation and setup can be performed solely by an operator who has no technical knowledge of XML and XSLT transformation. No separate file for style mapping is required, as everything is embedded in the InDesign file.

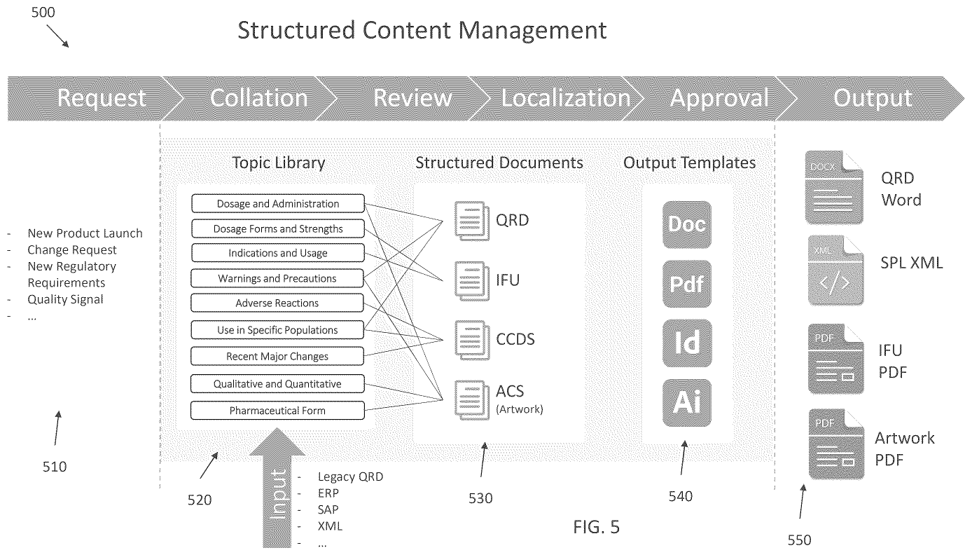

A file architecture and methodology as described above permits a workflow 500 such as is depicted in FIG. 5, wherein a user can request a change to the content in step 510 (e.g. prompted by a new product launch, change request, new regulatory requirement, quality signal, etc.), and modify the corresponding topic in a topic library in step 520 (e.g. dosage and administration, dosage forms and strengths, indications and usage, warnings and precautions, adverse reactions, use in specific populations, recent major changes, qualitative and quantitative information, or pharmaceutical form) based upon input from a legacy QRD, an enterprise resource planning (ERP) system (such as an SAP® system), or an XML file. The results of the modification can be viewed across multiple structured documents (e.g. QRD, IFU, Company core data sheet (CCDS), or ACS Artwork documents) 530 and those structured documents may be output in whatever form may be required (e.g. Word, XML, PDF) in step 550 in accordance with any number of output templates (e.g. .doc, .pdf, .id, .ai) 540. The workflow between requesting step 510 and output step 550 may also include localization steps (e.g. translation, consideration of local laws) and approval (e.g. by marketing, legal, management or other stakeholders).

Embodiments may include a user interface that permits a user to see how the various content is integrated with the artwork during editing. The user interface may further allow the user to select a portion of content to be edited, in which case the editor may provide the user with information regarding every instance (e.g. each document) in which that specific piece of content is used, as well as status information about each instance. Status information may show when the content was last edited, version number, and content status (i.e. whether that content is being actively edited elsewhere or used in a document that is under active editing). Each item of content may include information identifying content managers having authorization to permit the changes. Thus, whenever a user makes a change, each content manager may be given an automatic notification of the change (i.e. via email, text message, or via notification within the application software or via a messaging component dedicated to the application software). The content manager may be required to affirmatively approve that change before it can be implemented across the various artwork documents implicated. The editor user interface may also advise whether the change, if implemented, violates any artwork-based rules. For example, if a change to text will cause the text to overflow a predetermined text box size, the user may be notified of a “text overflow.” Thus, the user will be prompted to make changes to the artwork and/or modify the requested change in content to avoid unexpected consequences from the change. The editor may permit a user to undertake a text search for key words to locate the content to be edited within a document. Changes that implicate a need for translation or regulatory approval may be flagged by the editor to alert the user.

The described content management process is more efficient than prior art processes, and is expected to foster better quality and compliance to the content produced for different channels. The system and process permits coordination of regulatory efforts across company headquarters, affiliates, and partners within a single system tightly integrated with label & Packaging departments, with expected substantial reduction in labeling/IFU and submission document creation costs through facilitating reuse of content across multiple outputs. The system and method is also expected to significantly reduce risk and reduce the number or recalls through the implementation of automated XML publishing and is also expected to dramatically improve translation quality. The solution as described is also expected to reduce turnaround time for changes and potentially eliminate the need for in-country reviews for changes that have already been vetted or that do not implicate country-based changes. Structured Conent Management as described herein enables management of content, tracking of editing, and handling of local variants and translations while promoting re-use. Submission documents, IFUs and labels can automatically be generated from Structured Content as described herein, reducing the lead time of content authoring and artwork generation from months to weeks with increased compliancy and error reduction. The same structured content may thus be used for creating packaging as well as leaflets and other text-based documents.

The solution enables closer integration of textual changes combined with non-text output in complex documents using systems historically intended for managing artwork updates. The solution also provides traceability via which a user can find each use of each element everywhere in the system wherein changes in inputs are linked to physical output.

The textual content information as referred to herein may include, for example and without limitation, information relating to dosage or administration of the selected product, form or strength of the selected product, indications or usage for the selected product, warnings or precautions relating to the selected product, adverse reactions associated with the selected product, data regarding use in specific populations of the selected product, material changes in the selected product over a predefined amount of time, qualitative and quantitative information about the selected product, and compositional structure of the selected product. The textual content may be input via a user interface (e.g. by a user typing content using a keyboard), or may be machine captured from a pre-existing document, including capture from a native document (e.g. a Word document), a consolidated document (e.g. a PDF), or capture from an image (e.g. using OCR). For example, when initially populating a database for use in connection with embodiments as herein described, a user may scan existing packages or documents to extract the textual content, and then may tag and identify selected subsets of the textual content for incorporation in the database.

The artwork documents as described herein may include, in addition to placeholders for the textual content (e.g. a fillable field), passages of generic textual content into which the structured content may be inserted. Embodiments may include a nested structure in which one area of modifiable content may be nested within another area of modifiable content. Thus, for example, content corresponding to a dosage form may be nested within a generic passage about the drug chemistry that is not affected by dosage form, wherein both the dosage form and the generic passage may be uniquely identified an capable of modification.

Although discussed herein with respect to a preferred embodiment with reference to certain file types, it should be understood that the invention is not limited to any particular implementation, file type, or software compatibility.

### SUPPORTING HARDWARE

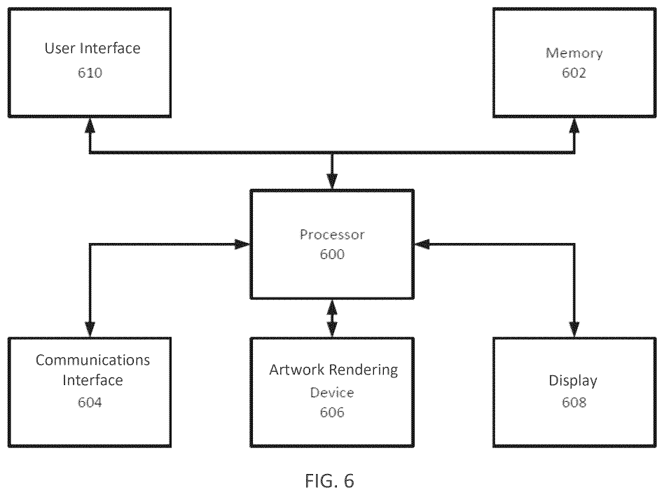

FIG. 6 is a block diagram of hardware components of various devices that may form the components of exemplary systems for performing the processes as described herein. Computers as described throughout the specification include at least one of the hardware components shown in FIG. 6 and may comprise specially-programmed personal computers (including but not limited to mobile devices), servers accessible via a global communication network, or some combination thereof. These hardware components include but are not limited to processor 600 (e.g. CPU), memory 602 for storing data and programming instructions for supporting the operation of processor 600, a user interface 610 (e.g. keyboard, mouse, touchscreen display, etc.) for receiving instructions from the user, display 608, communications interface 604 (e.g. wired, wireless, Bluetooth, WiFi, etc.) for communication among the devices (including but not limited to across a global computer network) and for transmitting message (e.g. via text or email) as described herein), and artwork rendering device 606. The artwork rendering device 606 may comprise a printer for printing physical documents, an e-publishing interface for composing electronic documents, a raster image processor (RIP) for converting a PDF to an imaging file for imaging a printing plate for use and a printing press configured to use such a plate for printing labels or product packaging, and the like. The artwork rendering device may be configured to receive files of any one of the output formats as described herein, without limitation, and may include a single component, or multiple components connected to one another or configured in a serial workflow. Other devices, such as printers, scanners, sensors, and the like (not shown) may also be connected to the system.

The instructions, programming, or application(s) may be software or firmware used to implement the device functions associated with the device such as the computer described throughout this description. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

It should be understood that all of the figures as shown herein depict only certain elements of an exemplary system, and other systems and methods may also be used. Furthermore, even the exemplary systems may comprise additional components not expressly depicted or explained, as will be understood by those of skill in the art. Accordingly, some embodiments may include additional elements not depicted in the figures or discussed herein and/or may omit elements depicted and/or discussed that are not essential for that embodiment. In still other embodiments, elements with similar function may substitute for elements depicted and discussed herein.

Any of the steps or functionality of the system and method for converting graphic files for printing can be embodied in programming or one more applications as described previously. According to some embodiments, “function,” “functions,” “application,” “applications,” “instruction,” “instructions,” or “programming” are program(s) that execute functions defined in the programs. Various programming languages may be employed to create one or more of the applications, structured in a variety of manners, such as object-oriented programming languages (e.g., Objective-C, Java, or C++), procedural programming languages (e.g., C or assembly language), or firmware. In a specific example, a third party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the steps herein described and/or shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Although the invention is illustrated and described herein with reference to specific embodiments, the invention is not intended to be limited to the details shown. Rather, various modifications may be made in the details within the scope and range of equivalents of the claims and without departing from the invention.

1. A computer-implemented process for creating structured documents associated with a selected product, the process comprising the steps of:
a) receiving and storing in a computer memory media, an updatable database embodying machine-readable instructions corresponding to one or more instances of textual content information relating to the selected product, each instance having a unique identifier but devoid of any stylistic or positional information;
b) generating, using a computer processor, a first artwork template file for a first structured document, the first artwork template file including at least one first placeholder embodying the unique identifier corresponding to at least one of the one or more instances of textual content information accessed from the database, the first artwork template file comprising all stylistic and positional information associated with presentation of the at least one instance in the first structured document; and
c) generating, using a computer processor, a second artwork template file for a second structured document different from the first structured document, the second artwork template file including at least one second placeholder embodying the unique identifier corresponding to at least one of the one or more instances of textual content information accessed from the database, the second artwork template file comprising all stylistic and positional information associated with presentation of the at least one instance in the second structured document.

2. The computer-implemented process of claim 1, wherein the first structured document embodies packaging or label artwork and second structured document embodies a non-packaging, non-labelling-related document.

3. The computer-implemented process of claim 2, wherein the non-packaging, non-labelling-related document comprises a regulatory submission, a printed physical document, or an e-published document.

4. The computer-implemented process of claim 3, wherein the printed physical document comprises instructions for use, a product insert, or a combination thereof.

5. A computer-implemented management system for creating structured documents associated with a selected product, the system comprising:
a computer processor;
a user interface connected to the computer processor;
non-transitory computer memory media accessible by the computer processor and having a first portion programmed with machine-readable instructions for causing the computer processor to execute the steps of claim 1.

6. Non-transitory computer memory media programmed with machine-readable instructions for causing a computer processor to execute the steps of claim 1.

7. The computer-implemented process of claim 1, wherein the selected product is a healthcare-related product.

8. The computer-implemented process of claim 1, wherein the one or more instances of textual content is selected from the group consisting of:
i) dosage or administration of the selected product,
ii) form or strength of the selected product,
iii) indications or usage for the selected product,
iv) warnings or precautions relating to the selected product,
v) adverse reactions associated with the selected product,
vi) data regarding use in specific populations of the selected product,
vii) material changes in the selected product over a predefined amount of time,
viii) qualitative and quantitative information about the selected product, and
ix) compositional structure of the selected product.

9. The computer-implemented management system of claim 5, wherein the one or more instances of textual content is selected from the group consisting of:
i) dosage or administration of the selected product,
ii) form or strength of the selected product,
iii) indications or usage for the selected product,
iv) warnings or precautions relating to the selected product,
v) adverse reactions associated with the selected product,
vi) data regarding use in specific populations of the selected product,
vii) material changes in the selected product over a predefined amount of time,
viii) qualitative and quantitative information about the selected product, and
ix) compositional structure of the selected product.

10. The non-transitory computer memory media of claim 6, wherein the one or more instances of textual content is selected from the group consisting of:
i) dosage or administration of the selected product,
ii) form or strength of the selected product,
iii) indications or usage for the selected product,
iv) warnings or precautions relating to the selected product,
v) adverse reactions associated with the selected product,
vi) data regarding use in specific populations of the selected product,
vii) material changes in the selected product over a predefined amount of time,
viii) qualitative and quantitative information about the selected product, and
ix) compositional structure of the selected product.

11. The computer-implemented management system of claim 5, wherein the selected product is a healthcare-related product.

12. The non-transitory computer memory media of claim 6, wherein the selected product is a healthcare-related product.
